(19) United States
(12) Patent Application Publication
(10) Pub. No.: US 2016/0343250 A1
(43) Pub. Date: Nov. 24, 2016

(54) EVALUATION METHOD, INFORMATION PROCESSING APPARATUS, AND COMPUTER-READABLE RECORDING MEDIUM

(71) Applicants: FUJITSU LIMITED, Kawasaki-shi (JP); NATIONAL UNIVERSITY CORPORATION EHIME UNIVERSITY, Matsuyama-shi (JP)

(72) Inventors: Toshio Yoshii, Ehime (JP); Kosei Takano, Fujimino (JP)

(21) Appl. No.: 15/159,466

(22) Filed: May 19, 2016

(30) Foreign Application Priority Data
May 22, 2015 (JP) 2015-104840

(51) Int. Cl. G08G 1/01; G08G 1/0962

(52) U.S. Cl. CPC G08G 1/0141; G08G 1/0129; G08G 1/0962

(57) ABSTRACT

An evaluation method includes: collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group, by a processor; and evaluating the specific area based on a result of comparison between a tendency of values indicated by the pieces of the data of the travel speeds collected for the first vehicle group and a tendency of values indicated by the pieces of the data of the travel speeds collected for the second vehicle group, by the processor.

### CROSS-REFERENCE TO RELATED APPLICATION

This application is based upon and claims the benefit of priority of the prior Japanese Patent Application No. 2015-104840, filed on May 22, 2015, the entire contents of which are incorporated herein by reference.

### FIELD

The embodiment discussed herein is related to an evaluation method, a computer-readable recording medium having stored therein an evaluation program, and an information processing apparatus.

There is a system that specifies a spot where a hazardous condition involving sudden braking has occurred on a travel route from travel information on a vehicle, and presents the specified spot as a hazardous condition hotspot to the vehicle. A driver of the vehicle who has received the presentation can recognize the hazardous condition involving sudden braking when passing through the hazardous condition hotspot, so that the driver can be careful and can take safety measures, such as deceleration.

Patent Document 1: Japanese Laid-open Patent Publication No. 2002-222491

Patent Document 2: Japanese Laid-open Patent Publication No. 2003-123185

However, in the above-described related technology, it is difficult to precisely evaluate a degree of hazard (hereinafter, referred to as an accident risk) indicating the probability of an accident in each spot, and to accurately extract an area with a high accident risk. For example, if a spot where a hazardous condition involving sudden braking has occurred is reported as the hazardous condition hotspot, accident risks other than the sudden braking are not precisely evaluated. Therefore, an area with a high accident risk due to a cause other than the sudden braking is not presented to a driver, and it is difficult to remind the driver to be careful enough.

### SUMMARY

According to an aspect of the embodiments, an evaluation method includes: collecting pieces of data of travel speeds corresponding to positions included in a specific area for each of a first vehicle group and a second vehicle group, based OR a piece of data of a travel speed corresponding to a position of each of vehicles included in the first vehicle group and a piece of data of a travel speed corresponding to a position of each of vehicles included in the second vehicle group, by a processor; and evaluating the specific area based on a result of comparison between a tendency of values indicated by the pieces of the data of the travel speeds collected for the first vehicle group and a tendency of values indicated by the pieces of the data of the travel speeds collected for the second vehicle group, by the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a calculation of a travel speed difference;

FIG. 2 is a diagram illustrating an example of an information processing system according to an embodiment;

FIG. 3 is a diagram for explaining contents stored in a probe data DB and an evaluation information DB;

FIG. 4 is a flowchart illustrating an example of an operation performed by an information processing apparatus according to the embodiment;

FIG. 5 is a flowchart illustrating an example of an evaluation process;

FIG. 6 is a diagram for explaining an example of display on a navigation screen;

FIG. 7 is a diagram for explaining an example of display on a map screen;

FIG. 8 is a diagram for explaining an example of display on an electronic message board; and

FIG. 9 is a block diagram illustrating an example of a hardware configuration of the information processing apparatus.

### DESCRIPTION OF EMBODIMENTS

Preferred embodiments will be explained with reference to accompanying drawings. Components having the same functions are denoted by the same symbols in the embodiment, and the same explanation will not be repeated. The evaluation method, the evaluation program, and the information processing apparatus described in the following embodiments are examples, and the embodiments are not limited thereto. The embodiments described below may appropriately be combined as long as no contradiction is derived.

Relationship between variations in a travel speed and an accident risk

If variations in a travel speed between vehicles driving back and forth with respect to each other are large, a vehicle platoon is likely to be formed, and passing behaviors or lane changing behaviors are increased. Therefore, relative motion of the vehicles becomes complicated and this is likely to trigger an accident. Incidentally, a main cause of the variations in the travel speed may be a difference between vehicle types, such as between a general vehicle and a heavy vehicle.

For example, a heavy cargo-carrying commercial vehicle (with a gross vehicle weight of 8 tons or greater or with a maximum loading capacity of 5 tons or greater) is obligated to install a speed limiting device (speed limiter) in order to prevent acceleration exceeding 90.0 km/h. Therefore, an average speed of a general vehicle, such as an ordinary vehicle, is higher than an average speed of a heavy cargo-carrying commercial vehicle.

Therefore, a relationship between the variations in the travel speed and the accident risk in each road section that is obtained by dividing a road in units of 100 meters (m) was examined by using probe car data (hereinafter, referred to as probe data) and traffic accident data in a predetermined section (target section).

The probe data is data of a travel path acquired from the probe car. The probe car is only one of passing vehicles, but can acquire continuous data of the travel path and therefore can recognize a traffic flow condition in a road section that is not covered by a vehicle detector, Furthermore, by using pieces of the probe data obtained from a plurality of probe cars, it becomes possible to recognize variations in the travel speed or acceleration.

The probe data used in the examination includes probe data of a commercial vehicle and probe data of a general vehicle. The probe data of the commercial vehicle is data acquired from a cargo-carrying commercial vehicle with a maximum loading capacity of 5 tons or greater and a gross vehicle weight of 8 tons or greater, and provides a position coordinate, a speed, acceleration, and the like of the vehicle in units of 1 second. In the examination, pieces of data of a total of 655 trips of 134 commercial vehicles that passed through the target zone are used. The probe data of the commercial vehicle provides the number of passing vehicles, an average speed, and the like in units of 15 minutes for each road section of 100 meters.

As the traffic accident data, pieces of data of 264 accidents that occurred in the past 4 years in the target section are used. The traffic accident data includes date and time of occurrence of an accident, a spot of the occurrence, a type of the accident, and the like.

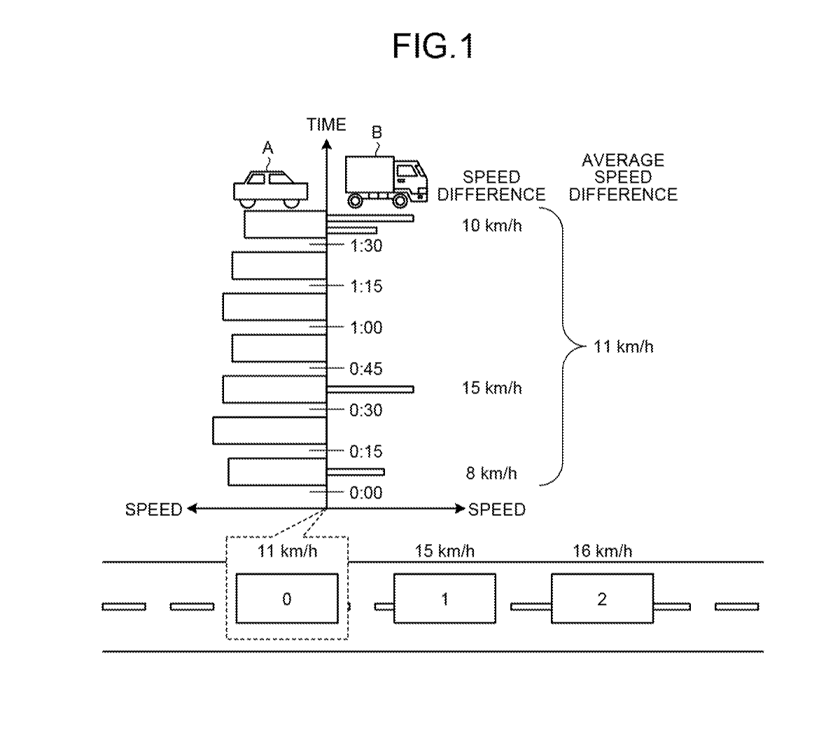

In the examination, as an index indicating variations in the travel speed, a travel speed difference between an average speed of the commercial vehicle and an average speed of the general vehicle was used. FIG. 1 is a diagram for explaining a calculation of the travel speed difference. As illustrated in FIG. 1, with respect to each time zone in which a travel speed of a commercial vehicle B was obtained, a speed difference in each time zone was obtained by subtracting the travel speed of the commercial vehicle B from an average speed of a general vehicle A for each road section. Then, a travel speed difference between the general vehicle A and the commercial vehicle B in the section was obtained by calculating an arithmetic mean of the obtained speed differences. For example, in the section illustrated in the drawing, there is a speed difference of 11 km/h, and the number of accidents in the traffic accident data is zero.

Subsequently, to statistically examine a relationship between the travel speed difference and the number of accidents, a single regression model was established, where the number of accidents was used as an explained variable and the speed difference between the general vehicle A and the commercial vehicle B was used as an explanatory variable, and model estimation was performed. A table below illustrates a result of the model estimation.

TABLE 1

| Explanatory | Regression | |
|---|---|---|
| Variable | Coefficient | t-Value |
| Constant Term | −0.0965 | −0.42 |
| Speed Difference | 0.148 | 3.70 |
| (km/h) | | |

| | |
|---|---|
| Number of Samples | 360 |
| R² Value | 0.0368 |

This result indicates that the number of accidents significantly increases with an increase in the speed difference, that is, the accident risk increases with an increase in the variations in the travel speed. For example, according to the regression coefficient, in a section in which the travel speed difference is 10 km/h, the number of accidents is increased by 1.5 in 4 years as compared to a section in which there is no speed difference.

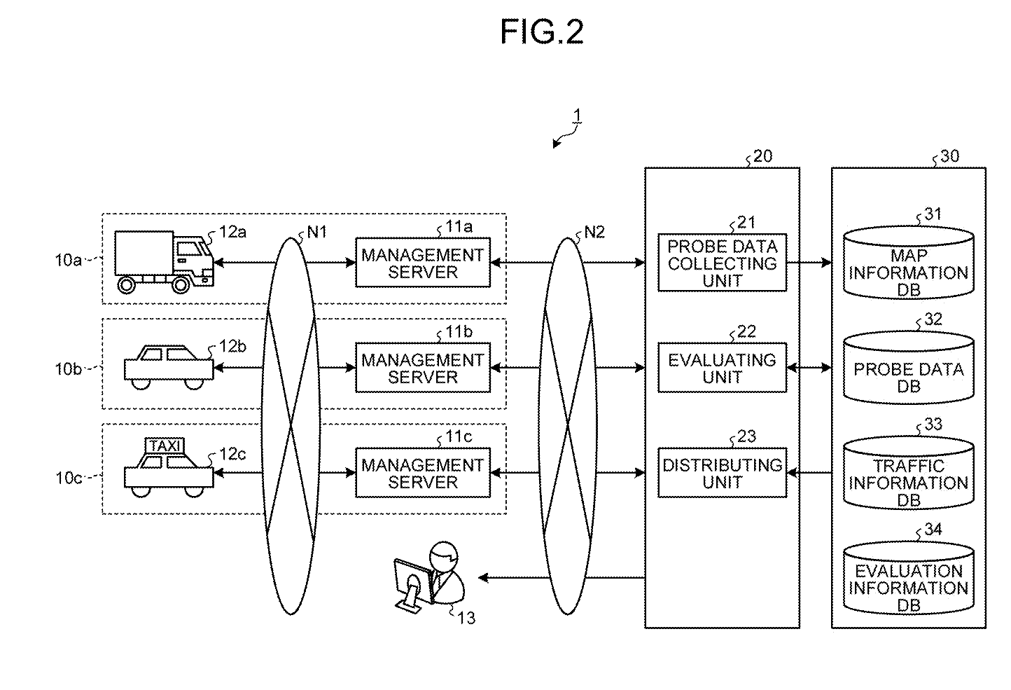

An embodiment below is an example of an information processing system that evaluates an accident risk in each area (road section) by using pieces of prove data of a plurality of vehicles. The information processing system of the embodiment accurately evaluates an area with a high accident risk by using the above-described relationship between the variations in the travel speed and the accident risk. FIG. 2 is a diagram illustrating an example of an information processing system 1 according to the embodiment.

As illustrated in FIG. 2, the information processing system 1 includes collecting systems 10a, 10b, and 10c, a terminal device 13, an information processing apparatus 20, and a storage device 30. The collecting systems 10a, 10b, and 10c are systems that collect pieces of prove data including travel speeds corresponding to positions from operation recording devices (not illustrated) installed in vehicles 12a, 12b, and 12c, respectively, and provide various services based on the pieces of the collected prove data.

For example, in the operation recording devices installed in the vehicles 12a, 12b, and 12c, a travel distance, a travel speed, and an operation condition, such as sudden starting, rapid acceleration, or rapid deceleration, are recorded in association with position information or the like that is acquired by a global positioning system (GPS) function or the like at the time of travelling. The operation recording devices installed in the vehicles 12a, 12b, and 12c are connected to management servers 11a, 11b, and 11c via a communication network N1. The communication network N1 includes, for example, a public network, such as the Internet, a wireless network, such as a mobile phone, and a network, such as a local area network (LAM).

The management servers 11a, 11b, and 11c collect pieces of prove data indicating the operation conditions recorded in the operation recording devices installed in the vehicles 12a, 12b, and 12c, and manage the operation conditions of the respective vehicles. Then, the management servers 11a, 11b, and 11c provide services corresponding to the operation conditions of the respective vehicles.

For example, the collecting system 10a is an operation management system of a forwarding agent, and configured to collect probe data of the vehicle 12a that is a cargo-carrying commercial vehicle of the forwarding agent and manage operations of the vehicle 12a. Furthermore, the collecting system 10b is a navigation system of the vehicle 12b for which a user is registered in advance, and configured to aggregate pieces of probe data of the vehicle 12b and distribute pieces of data of a congestion situation or a traffic jam forecast of each road section to the vehicle 12b. Therefore, the navigation device of the vehicle 12b can guide a route in accordance with the congestion situation or the traffic jam forecast obtained from the pieces of the aggregated probe data. Moreover, the collecting system 10c is a dispatch system of a taxi association, and configured to collect pieces of probe data of the vehicle 12c that is a taxi and manage allocation of the vehicle 12c.

Incidentally, the above-described collecting systems 10a, 10b, and 10c are examples, and vehicle types and the number of vehicles for collecting pieces of the probe data are not specifically limited. For example, the collecting system may be an operation management system that collects pieces of probe data of a motorcycle used for motorcycle mail delivery and manages delivery operations.

The terminal device 13 is a terminal device as a distribution destination to which the information processing apparatus 20 distributes an evaluation result of the accident risk in each road section. For example, as the terminal device 13, a terminal device such as a personal computer (PC) used by an observer in a traffic information center may be used. Furthermore, the terminal device 13 may be a navigation device installed in a vehicle travelling on a road, a display device that is installed in a service area (SA), a parking area (PA), or the like to provide road guidance, an electronic message board installed on a road, or the like.

The information processing apparatus 20 is, for example, a PC or the like, collects pieces of probe data of the vehicles 12a, 12b, and 12c from the management servers 11a, 11b, and 11c, and evaluates the accident risk in each road section based on the pieces of the collected probe data.

The information processing apparatus 20 is connected to the storage device 30. The information processing apparatus 20 is also connected to the management servers 11a, 11b, and 11c of the collecting systems 10a, 10b, and 10c and the terminal device 13 via a communication network N2. The communication network N2 includes, for example, a public network, such as the Internet, a wireless network, such as a mobile phone, and a network, such as a LAN. It may be possible to connect, to the communication network N2, a server device that is used for a traffic information communication system (Vehicle Information and Communication System (VICS) (registered trademark)) and that distributes traffic information including weather conditions, accident information, traffic control information, or the like, for example. The information processing apparatus 20 may acquire various kinds of information from the traffic information communication system connected to the communication network N2.

The information processing apparatus 20 includes functional units such as a probe data collecting unit 21, an evaluating unit 22, and a distributing unit 23, which are implemented by causing a central processing unit (CPU) or the like to execute a program.

The probe data collecting unit 21 collects pieces of probe data of the vehicles 12a, 12b, and 12c and pieces of vehicle information, such as vehicle types, of the vehicles 12a, 12b, and 12c from the management servers 11a, 11b, and 11c of the collecting systems 10a, 10b, and 10c. For example, the probe data collecting unit 21 periodically receives distributions of pieces of information (pieces of the probe data and the vehicle information, such as vehicle types, of the vehicles 12a, 12b, and 12c) managed by the management servers 11a, 11b, and 11c, and collects the pieces of the probe data and the vehicle information of the vehicles 12a, 12b, and 12c. Furthermore, the probe data collecting unit 21 collects the pieces of the probe data and the vehicle information of the vehicles 12a, 12b, and 12c by accessing a distribution source address that distributes the pieces of the probe data and the vehicle information of the vehicles 12a, 12b, and 12c. The probe data collecting unit 21 stores the pieces of the collected probe data of the vehicles 12a, 12b, and 12c and the pieces of the collected vehicle information, such as vehicle types, of the vehicles 12a, 12b, and 12c in a probe data database (DB) 32.

Incidentally, as for the vehicle types, it may be possible to use classifications other than the general vehicle A and the commercial vehicle B that are used to describe the relationship between the variations in the travel speed and the accident risk. For example, it may be possible to use classifications based on the Road Traffic Act, that is, classifications such as a heavy vehicle, a medium vehicle, an ordinary vehicle, a heavy special vehicle, a small special vehicle, a heavy motorcycle, and an ordinary motorcycle. Furthermore, it may be possible to use classifications based on the Road Tracking Vehicle Act, that is, classifications such as an ordinary vehicle, a small vehicle, a light vehicle, a heavy special vehicle, and a small special vehicle.

In the management servers 11a, 11b, and 11c, pieces of identification information for identifying the vehicles 12a, 12b, and 12c and pieces of the above-described vehicle information indicating the vehicle types or the like are registered in advance. The pieces of the probe data of the vehicles 12a, 12b, and 12c are managed in association with the pieces of the identification information of the vehicles 12a, 12b, and 12c. Therefore, the probe data collecting unit 21 can collect the pieces of the vehicle information of the vehicles 12a, 12b, and 12c when collecting the pieces of the probe data of the vehicles 12a, 12b, and 12c.

Furthermore, the probe data collecting unit 21 may collect all pieces of the probe data of the vehicles 12a, 12b, and 12c managed by the management servers 11a, 11b, and 11c, or collect part of the pieces of the probe data. For example, the pieces of the probe data may include data indicating travel in a road section that is not related to a road section for which the accident risk is evaluated. Therefore, the probe data collecting unit 21 may narrow down the pieces of the probe data based on the position information included in each piece of the probe data, and may collect pieces of the probe data of a predetermined road section.

The evaluating unit 22 evaluates an accident risk in each road section based on the pieces of the probe data, which are collected from the vehicles 12a, 12b, and 12c and which are stored in the probe data DB 32. Furthermore, the evaluating unit 22 stores an evaluation result including the accident risk in each road section in an evaluation information DB 34.

Specifically, the evaluating unit 22 classifies the pieces of the probe data of the vehicles 12a, 12b, and 12c into a first vehicle group and a second vehicle group for each vehicle type. As one example, as the classifications such as the first vehicle group and the second vehicle group, it may be possible to classify vehicles into a commercial vehicle, such as a cargo-carrying commercial vehicle, and a general vehicle other than the commercial vehicle. Furthermore, it may be possible to classify vehicles into a predetermined vehicle type (for example, a heavy vehicle) and a different vehicle type (for example, an ordinary vehicle) other than the predetermined vehicle type according to the classifications based on the Road Traffic Act or the Road Tracking Vehicle Act.

Then, the evaluating unit 22 compares an aggregated value of the pieces of the probe data of the vehicles included in the first vehicle group and an aggregated value of the pieces of the probe data of the vehicles included in the second vehicle group for each road section. As one example, the evaluating unit 22 aggregates an average value of the travel speeds of the vehicles included in each of the first vehicle group and the second vehicle group, and compares the aggregated average values of the travel speeds. Incidentally, a value aggregated by the evaluating unit 22 may be any value as long as the tendency of a variation between the travel speed of the vehicles in the first vehicle group and the travel speed of the vehicles in the second vehicle group is indicated. For example, the value aggregated by the evaluating unit 22 may be any of a median value and a degree of distribution of the travel speeds, in addition to the average values of the travel speeds of the vehicles included in the first vehicle group and the second vehicle group.

The evaluating unit 22 evaluates the accident risk in each road section based on a result of comparison between the aggregated value of the first vehicle group and the aggregated value of the second vehicle group for each road section. Specifically, the evaluating unit 22 evaluates that the accident risk is increased with an increase in a variation between the travel speed of the vehicles in the first vehicle group and the travel speed of the vehicles in the second vehicle group as a result of the comparison. As one example, the evaluating unit 22 evaluates that the accident risk is increased with an increase in a difference between an average value of the travel speeds in the first vehicle group and an average value of the travel speeds in the second vehicle group. In the evaluation of the accident risk, it may foe possible to multiply a value indicating the degree of the variation between the travel speeds (for example, a difference in the average speed of the travel speeds) by a predetermined coefficient to quantify the evaluation. Alternatively, it may be possible to perform evaluation for each level, such as “high”, “medium”, and “low”, in accordance with the value indicating the degree of the variation between the travel speed.

In addition, the evaluating unit 22 sets an alert indicating whether to give an alert (warning) in accordance with approaching or entrance to each road section, based on the evaluation of the accident risk in each road section. For example, the evaluating unit 22 may perform setting to give an alert for a road section for which the evaluated accident risk is higher than a predetermined value (or level). The evaluating unit 22 stores, as an evaluation result, the evaluated accident risk and the alert setting for each road section as described above in the evaluation information DB 34.

The distributing unit 23 refers to the evaluation result stored in the evaluation information DB 34, and distributes information on the accident risk in each road section evaluated by the evaluating unit 22 to the terminal device 13.

The storage device 30 is a storage device including a storage medium for storing various programs and various kinds of data. The storage device 30 may be referred to as an external storage device. Examples of the storage device 30 include a solid state drive device and a hard disk drive device. Furthermore, the storage device 30 may include a portable storage medium, such as a compact disc (CD) drive device, a digital versatile disc (DVD) drive device, and a Blu-ray (registered trademark) disc (BD) drive device. Incidentally, the information processing apparatus 20 and the storage device 30 may be configured as, for example, parts of a cloud that is a group of computers on a network.

The storage device 30 includes a map information DB 31, the probe data DB 32, a traffic information DB 33, and the evaluation information BB 34 that are to be referred to by the information processing apparatus 20 or to be a destination for storing managed data.

The map information DB 31 is a database for storing map information. The map information DB 31 includes a point of interest (POI) of data of a main facility, road data (a route, a distance, a width, a traffic control speed, and the like of each road), identification information on an intersection, geographical name data, map data, or the like.

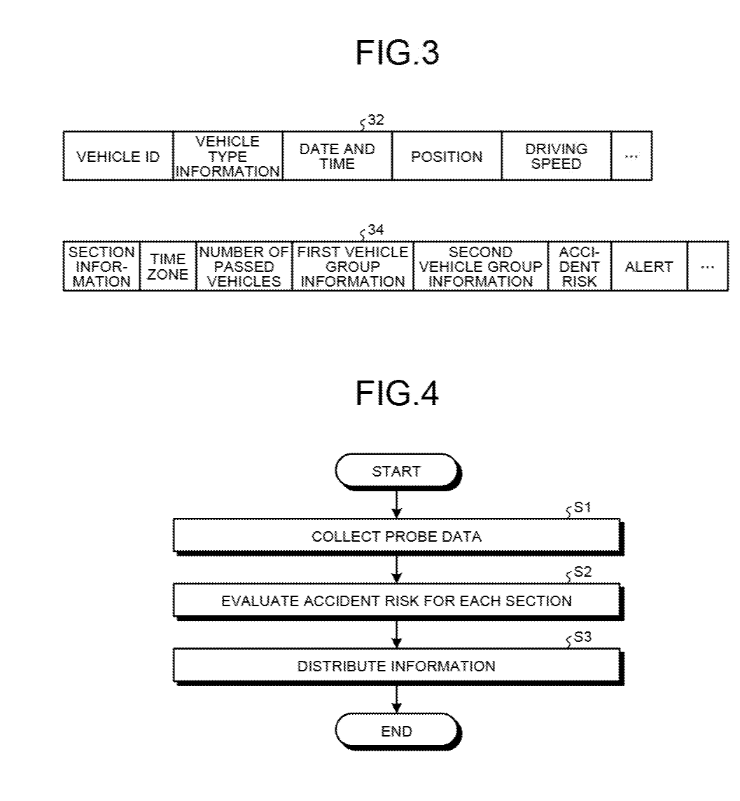

The probe data DB 32 is database for storing pieces of probe data collected from the vehicles 12a, 12b, and 12c. FIG. 3 is a diagram for explaining contents stored in the probe data DB 32 and the evaluation information DB 34.

As illustrated in FIG. 3, for example, the probe data DB 32 stores therein information for each of items such as “vehicle ID”, “vehicle type information”, “date and time”, “position”, and “travel speed”. The “vehicle ID” is identification information for identifying each vehicle in the pieces of the prove data collected from the vehicles 12a, 12b, and 12c. The “vehicle type information” is information indicating a type of each vehicle in the pieces of the prove data collected from the vehicles 12a, 12b, and 12c. In the “vehicle ID” and the “vehicle type information”, contents based on pieces of vehicle information that are acquired together with the pieces of the prove data collected from the vehicles 12a, 12b, and 12c are described. The “date and time”, the “position”, and the “travel speed” are pieces of information on a travel path indicating the date and time, the position, and the speed at the time of travelling, based on the pieces of the probe data of the vehicles 12a, 12b, and 12c.

The traffic information DB 33 is a database for storing traffic information that is distributed from, for example, a traffic information communication system, such as a VICS. In the traffic information DB 33, pieces of distributed traffic information are sequentially stored. Therefore, the traffic information DB 33 makes it possible to refer to the traffic information in a predetermined time zone.

The evaluation information DB 34 is a database for storing evaluation information including the accident risk in each road section evaluated by the evaluating unit 22. For example, the evaluation information DB 34 stores therein information for each of items such as “section information”, “time zone”, “number of passed vehicles”, “first vehicle group information”, “second vehicle group information”, “accident risk”, and “alert” (see FIG. 3).

The “section information” is information indicating each road section, and is, for example, information indicating points (kilopost) at both ends of a road section. The “time zone” is information indicating a period for evaluation, and is information indicating a time zone for evaluation, such as morning, daytime, evening, or night. If the evaluation is performed for each day or each date, information indicating a day or a date is stored in the “time zone”. The “number of passed vehicles” is information on the number of vehicles or the like that have passed through the road section indicated by the “section information” during the period for evaluation indicated by the “time zone”. The “first vehicle group information” is information on the first vehicle group, such as information indicating a type of vehicles included in the first vehicle group or an aggregated value of pieces of probe data of the vehicles included in the first vehicle group. The “second vehicle group information” is information on the second vehicle group, such as information indicating a type of vehicles included in the second vehicle group or an aggregated value of pieces of probe data of the vehicles included in the second vehicle group. The “accident risk” is information indicating an accident risk evaluated in a road section indicated by the “section information”. The “alert” is information indicating an alert that is set based on the evaluation of the accident risk in the road section indicated by the “section information”.

Next, examples of operations performed by the functional units such as the probe data collecting unit 21, the evaluating unit 22, and the distributing unit 23 of the information processing apparatus 20 will be described in detail. FIG. 4 is a flowchart illustrating an example of an operation performed by the information processing apparatus 20 according to the embodiment.

As illustrated in FIG. 4, when a process starts, the probe data collecting unit 21 collects pieces of prove data of the vehicles 12a, 12b, and 12c from the management servers 11a, 11b, and 11c (S1). The pieces of the prove data collected at S1 are stored in the probe data DB 32 together with pieces of vehicle information, which are acquired from the management servers 11a, 11b, and 11c together with the pieces of the prove data and which indicate types of the vehicles 12a, 12b, and 12c.

Subsequently, the evaluating unit 22 performs an evaluation process of evaluating an accident risk for each road section based on the pieces of the probe data that are acquired from the vehicles 12a, 12b, and 12c and stored in the probe data DB 32, and storing an evaluation result in the evaluation information DB 34 (S2).

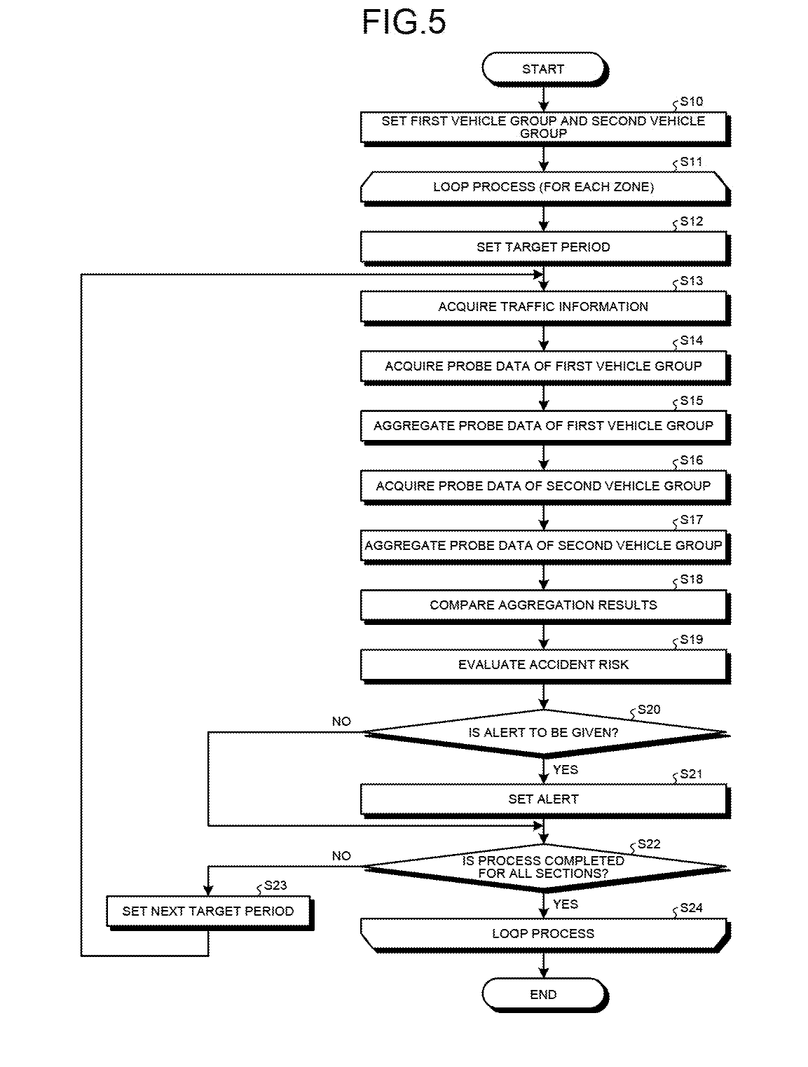

FIG. 5 is a flowchart illustrating an example of the evaluation process (S2). As illustrated in FIG. 5, when the evaluation process starts, the evaluating unit 22 sets vehicle types or the like for the first vehicle group and the second vehicle group (S10). As for the setting, it may be possible to perform the setting by reading registered setting of each vehicle group, which is registered in advance in setting information or the like in the storage device 30. Furthermore, it may be possible to perform the setting by displaying classifications of vehicle types on a display and receiving a selection of a vehicle type of each vehicle group through a graphical user interface (GUI) that receives an operation input from a keyboard or the like. Furthermore, in the setting at S10, the evaluating unit 22 may receive, through the GUI, setting of a road section (for example, a section between interchanges in a highway or the like) for which the accident risk is to be evaluated.

Subsequently, the evaluating unit 22 performs a loop process for each predetermined road section (for example, in units of kiloposts) of a road included in the map information DB 31, and evaluates the accident risk in each road section (S11 to S24). If the road section for which the accident risk is to be evaluated is set in advance, the loop process is performed for each section that is obtained by further dividing the road section (for example, in units of 100 meters). The evaluating unit 22 stores an evaluation result of the loop process for each section in the item corresponding to the “section information” in the evaluation information DB 34.

When the loop process starts, the evaluating unit 22 sets a target period for evaluation of the accident risk (S12). As the setting of the target period, a period corresponding to a period that has been registered in advance for evaluating the accident risk is to be set. For example, when the accident risk is evaluated for each time zone, such as morning, daytime, evening, or night, any of the time zones such as morning, daytime, evening, and night is set as the target period. Furthermore, when the accident risk is evaluated for each day, any of days such as Monday, Tuesday, Wednesday, Thursday, Friday, Saturday, and Sunday is set as the target period. Incidentally, when the accident risk is evaluated for each day, it may be possible to perform evaluation by further dividing each day into time zones.

Subsequently, the evaluating unit 22 refers to the traffic information DB 33 and acquires traffic information on the target period for a road section that is an evaluation target in the loop process (S13). The traffic information is, for example, the number of passed vehicles that have travelled through the road section, a traffic jam condition in the road section, or the like.

Subsequently, the evaluating unit 22 refers to the “vehicle type information” in the probe data DB 32, and acquires pieces of probe data of the respective vehicles included in the first vehicle group set at S10 (S14). Then, the evaluating unit 22 aggregates pieces of data corresponding to the target period for the road section as the evaluation target in the loop process, with respect to the pieces of the prove data of the first vehicle group acquired at S14 (S15). Specifically, the evaluating unit 22 extracts pieces of the prove data of vehicles that have travelled through the evaluation target road section in the target period, based on the “date and time” and the “position” in the pieces of the prove data of the first vehicle group. Then, the evaluating unit 22 aggregates the travel speeds of the pieces of the extracted prove data, and calculates an average value, a median value, a degree of distribution, or the like of the travel speeds of the first vehicle group.

Subsequently, the evaluating unit 22 refers to the “vehicle type information” in the probe data DB 32, and acquires pieces of prove data of the respective vehicles included in the second vehicle group set at S10 (S16). Then, the evaluating unit 22 aggregates pieces of data corresponding to the target period for the road section as the evaluation target in the loop process, with respect to the pieces of the prove data of the second vehicle group acquired at S16 (S17). Specifically, the evaluating unit 22 extracts pieces of the prove data of vehicles that have travelled through the evaluation target road section in the target period, based on the “date and time” and the “position” in the pieces of the prove data of the second vehicle group. Then, the evaluating unit 22 aggregates the travel speeds of the pieces of the extracted prove data, and calculates an average value, a median value, a degree of distribution, or the like of the travel speeds of the second vehicle group.

Subsequently, the evaluating unit 22 compares an aggregation result of the first vehicle group acquired at S15 and an aggregation result of the second vehicle group acquired at S17 (S18), and evaluates the accident risk in the target period for the road section that is the evaluation target in the loop process (S19). The evaluation of the accident risk is performed as described above such that, for example, the accident risk is increased with an increase in a difference between an average value of the travel speeds in the first vehicle group and an average value of the travel speeds in the second vehicle group.

Incidentally, the evaluation of the accident risk at S19 may be performed in accordance with the target period or the traffic information acquired at S13. Specifically, even when the difference between the average value of the travel speeds in the first vehicle group and the average value of the travel speeds in the second vehicle group is the same, the evaluation of the accident risk may be changed depending on the target period or the traffic information. For example, when the target period is night among the time zones of morning, daytime, evening, and night, the accident risk may be evaluated to be higher than that of daytime by multiplication by a predetermined coefficient (a value equal to or greater than 1). Similarly, if the number of passed vehicles or the congestion situation included in the traffic information is equal to or greater than a predetermined value, the accident risk may be evaluated to be higher than the case in which the number of passed vehicles or the congestion situation is smaller than the predetermined value.

Subsequently, the evaluating unit 22 determines whether to give an alert in accordance with approaching or entrance to the road section, based on the accident risk in the target period for the road section that is the evaluation target in the loop process (S20). For example, the evaluating unit 22 determines to give an alert when the accident risk is evaluated to be higher than a predetermined value (or a level).

If the alert is to be given (YES at S20), the evaluating unit 22. sets an alert corresponding to approaching or entrance in the time zone as the target period for the road section as the evaluation target in the loop process (S21). Incidentally, if the alert is not to be given (NO at S20), the process at S21 is skipped, and the process proceeds to S22.

As the setting of an alert at S21, it may be possible to set a warning simply indicating that the accident risk is high, or a warning to recommend a driving operation of reducing the accident risk. As the recommendation of the driving operation of reducing the accident risk, it may be possible to set a warning to recommend a driving operation of reducing a speed difference between the travel speed of the first vehicle group and the travel speed of the second vehicle group because the accident risk is increased due to an increase in the speed difference.

As one example, it may be possible to set a warning to reduce the speed difference by reducing the travel speed of the vehicle group having a higher travel speed. For example, vehicle type information indicating the vehicle group having a higher travel speed and contents of a warning (reduction in the travel speed) for a vehicle corresponding to the vehicle type information are set in the alert. Alternatively, if one of the travel speed of the first vehicle group and the travel speed of the second vehicle group is equal to or smaller than a predetermined value, it may be possible to set a warning to reduce the speed difference by increasing the travel speed of the vehicle class having the travel speed equal to or smaller than the predetermined value. For example, vehicle type information indicating the vehicle group having the travel speed equal to or smaller than the predetermined value and contents of a warning (increase in the travel speed) for a vehicle corresponding to the vehicle type information are set in the alert.

Subsequently, the evaluating unit 22 determines whether the evaluation process is completed for all of periods (for example, all of the time zones such as morning, daytime, evening, and night) (S22). If the process is not completed (NO at 322), the evaluating unit 22 sets a next target period (S23), and the process returns to S13. The evaluating unit 22 stores an evaluation result of each section through the above-described loop process (S11 to S24) in each item corresponding to the “section information” in the evaluation information DB 34.

Referring back to FIG. 4, after the evaluation process performed by the evaluating unit 22 (S2), the distributing unit 23 refers to the evaluation result stored in the evaluation information DB 34, and distributes information on the accident risk in each road section evaluated by the evaluating unit 22 to the terminal device 13 (S3). Specifically, pieces of information such as the “time zone”, the “number of passed vehicles”, the “first vehicle group information”, the “second vehicle group information”, the “accident risk”, and the “alert” for each road section indicated by the “section information” are distributed to the terminal device 13. Accordingly, the terminal device 13 displays the information distributed by the information processing apparatus 20 on a screen, so that it becomes possible to confirm the accident risk, the alert, or the like for each time zone in each road section.

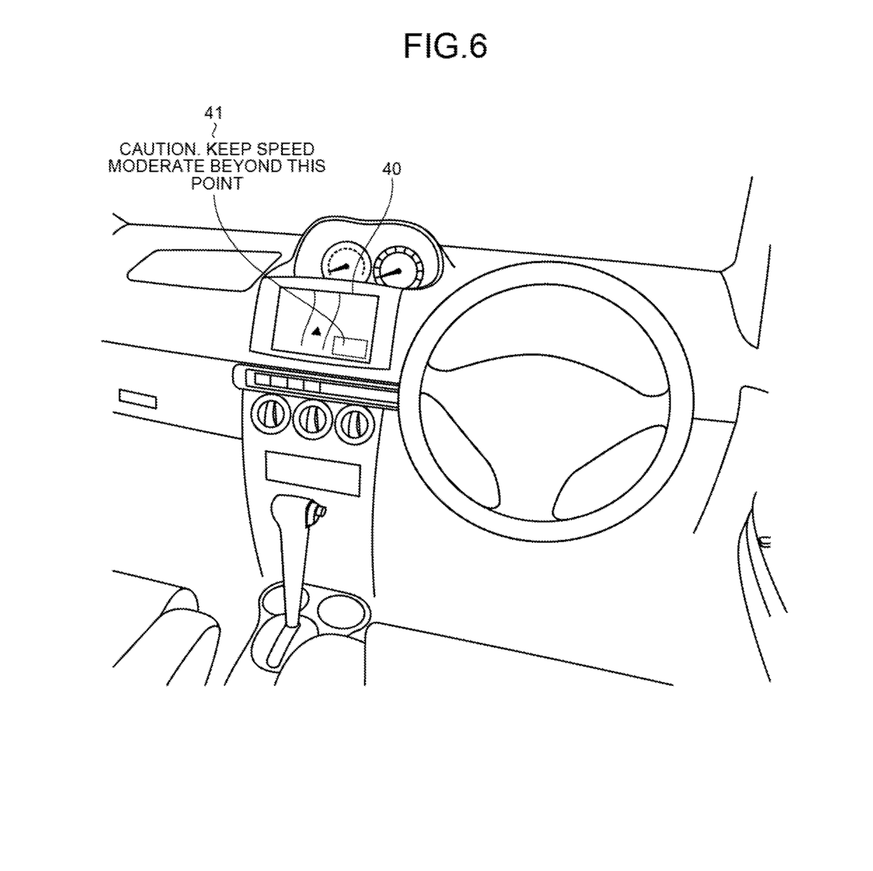

FIG. 6 is a diagram for explaining an example of display on a navigation screen 40. As illustrated in FIG. 6, the terminal device 13 (navigation device) installed in a vehicle may display alert display 41 on the navigation screen 40 based on the information distributed by the distributing unit 23 of the information processing apparatus 20. Specifically, the alert display 41 corresponding to a current position of the vehicle detected by the GPS is provided based on the “section information” and the “alert” included in the distributed information. For example, the alert display 41 is displayed in accordance with approaching or entrance to the road section for which the “alert” is set, Consequently, a driver can perform a driving operation corresponding to the alert display 41 on the navigation screen 40, and therefore can reduce the accident risk in the current position.

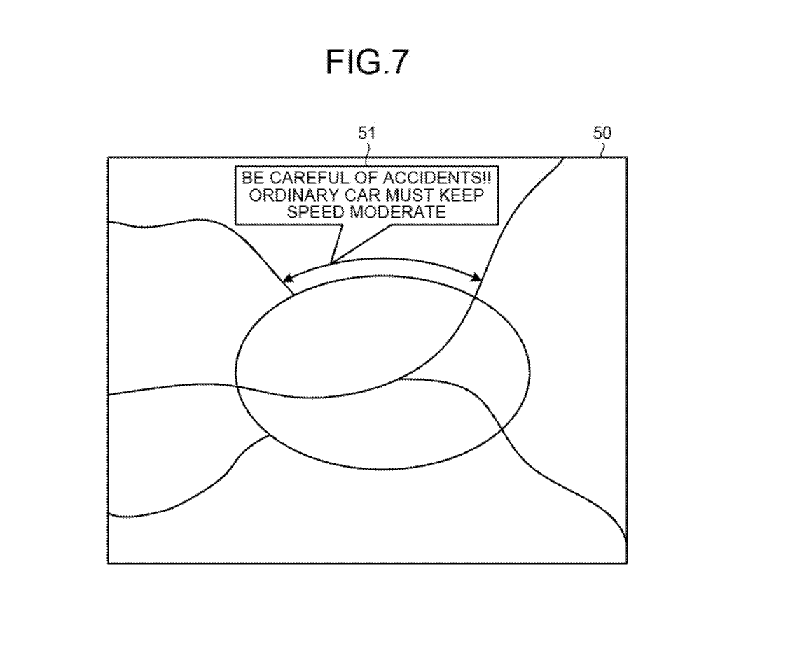

FIG. 7 is a diagram for explaining an example of display on a map screen 50. As illustrated in FIG. 7, the terminal device 13 provides alert display 51 in a corresponding section on a road on the map screen 50 based on the “section information” and the “alert” included in the information distributed by the distributing unit 23. Consequently, an operator of the terminal device 13 can recognize that the accident risk is increased due to variations in the travel speed in the road section in which the alert display 51 is displayed.

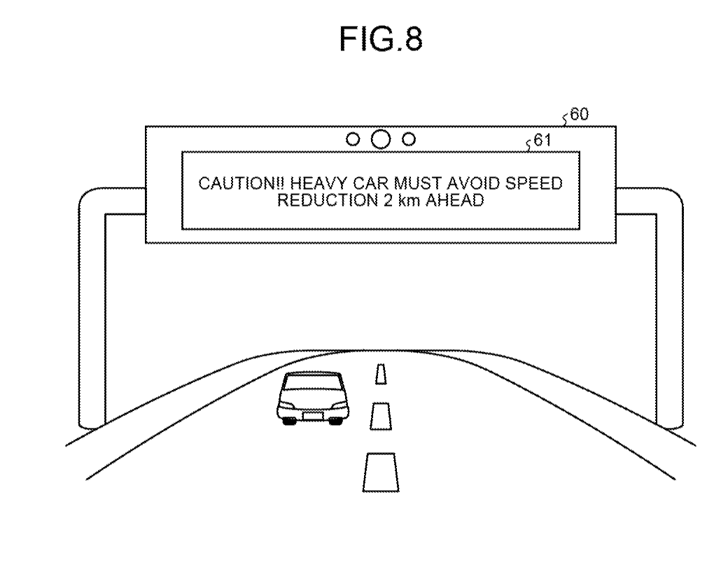

FIG. 8 is a diagram for explaining an example of display on an electronic message board 60. As illustrated in FIG. 8, the terminal device 13 may display alert display 61 on the electronic message board 60 placed on a road, based on the information distributed by the distributing unit 23 of the information processing apparatus 20. Specifically, the alert display 61 corresponding to a road section for which an alert is set is provided based on the “section information” and the “alert” included in the distributed information. Consequently, a driver can perform a driving operation corresponding to the alert display 61 on the electronic message board 60, and therefore can reduce the accident risk while driving the road on which the accident risk is expected to increase due to variations in the travel speed.

All or any part of various processing functions implemented by the information processing apparatus 20 may be executed on a CPU (or a microcomputer, such as a micro processing unit (MPU) or a micro controller unit (MCU)). Furthermore, all or any part of the various processing functions may be executed on a program analyzed and executed by a CPU (or a microcomputer, such as an MPU or an MCU), or on hardware using wired logic.

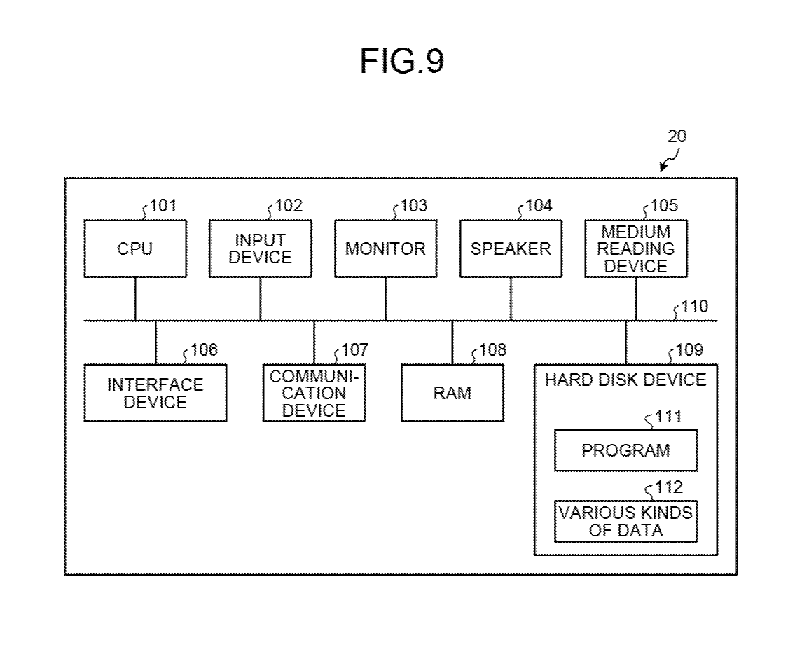

Incidentally, various processes described in the above-described embodiment are implemented by causing a computer to execute a program prepared in advance. Therefore, in the following, an example of a computer (hardware) that executes a program having the same functions as those of the above-described embodiment will be described. FIG. 9 is a block diagram illustrating an example of a hardware configuration of the information processing apparatus 20.

As illustrated in FIG. 9, the information processing apparatus 20 includes a CPU 101 that executes various arithmetic processes, an input device 102 that receives an input of data, a monitor 103, and a speaker 104. The information processing apparatus 20 also includes a medium reading device 105 that reads a program or the like from a storage medium, an interface device 106 for connecting to various devices, and a communication device 107 for establishing a communication connection with external devices by wire or wireless. The information processing apparatus 20 also includes a random access memory (RAM) 108 for temporarily storing various kinds of information and a hard disk device 109. The units (101 to 109) in the information processing apparatus 20 are connected to a bus 110.

The hard disk device 109 stores therein a program 111 for executing various processes described in the above embodiment. Furthermore, the hard disk device 109 stores therein various kinds of data 112 for implementing the program 111. The input device 102 receives, for example, an input of operation information from an operator of the information processing apparatus 20. The monitor 103 displays, for example, various screens operated by the operator. The interface device 106 is connected to, for example, a printing device or the like. The communication device 107 is connected to a communication network, such as a LAM, and exchanges various kinds of information with external devices via the communication network.

The CPU 101 reads the program 111 stored in the hard disk device 109, loads the program on the RAM 108, and executes the program to thereby perform various processes. Incidentally, the program 111 does not necessarily have to be stored in the hard disk device 109. For example, the information processing apparatus 20 may read the program 111 stored in a storage medium that the information processing apparatus 20 can read, and may execute the read program 111. Examples of the storage medium that the information processing apparatus 20 can read include a portable recording medium, such as a compact disc-ROM (CD-ROM), a digital versatile disc (DVD), or a universal serial bus (USB) memory, a semiconductor memory, such as a flash memory, and a hard disk drive. Furthermore, it may be possible to store the program in a device connected to a public line, the Internet, a LAN, or the like, and cause the information processing apparatus 20 to read the program from the device and execute the program.

According to an embodiment of the present invention, it is possible to accurately evaluate an area with a high accident risk.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An evaluation method comprising:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group, by a processor; and
evaluating the specific area based on a result of comparison between a tendency of values indicated by the pieces of the data of the travel speeds collected for the first vehicle group and a tendency of values indicated by the pieces of the data of the travel speeds collected for the second vehicle group, by the processor.

2. The evaluation method according to claim I, wherein evaluation of the specific area is evaluation related to a degree of hazard in the specific area, by the processor.

3. An evaluation method comprising:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group, by a processor; and
controlling whether to give an alert in accordance with approaching or entrance to the specific area depending on a result of comparison between a tendency of values indicated by the pieces of the data of the travel speeds collected for the first vehicle group and a tendency of values indicated by the pieces of the data of the travel speeds collected for the second vehicle group, by the processor.

4. The evaluation method according to claim 3, wherein the tendency is a tendency of an average value of the travel speeds, a median value of the travel speeds, or a degree of distribution of the travel speeds or any combination thereof, with respect to the pieces of the data of the travel speeds collected for each of the first vehicle group and the second vehicle group.

5. The evaluation method according to claim I, wherein the pieces of the data of the travel speeds of the first vehicle group and the pieces of the data of the travel speeds of the second vehicle group are collected by using different travel speed collecting systems, by the processor,

6. The evaluation method according to claim I, wherein the first vehicle group includes a commercial vehicle, and the second vehicle group includes vehicles other than the commercial vehicle.

7. The evaluation method according to claim 4, wherein the controlling includes determining to give an alert in accordance with approaching and entrance to an area in which the travel speed of the second vehicle group is higher than the travel speed of the first vehicle group by a predetermined value or greater, by the processor.

8. The evaluation method according to claim 4, wherein the alert is to output information for recommending a driving operation of reducing a speed difference between a travel speed of the first vehicle group and a travel speed of the second vehicle group, by the processor.

9. The evaluation method according to claim I, wherein the piece of the data of the travel speed corresponding to the position of each of the vehicles included in the first vehicle group includes information on a time at which the travel speed is detected,
the piece of the data of the travel speed corresponding to the position of each of the vehicles included in the second vehicle group includes information on a time at which the travel speed is detected,
the collecting includes collecting pieces of data of travel speeds included in a predetermined time zone among the pieces of the data of the travel speeds corresponding to respective positions included in the specific area, for each of the first vehicle group and the second vehicle group, by the processor, and
the evaluating includes evaluating the specific area in the predetermined time zone based on a result of comparison between a tendency of values indicated by the pieces of the data of the travel speeds included in the predetermined time zone collected for the first vehicle group and a tendency of values indicated by the pieces of the data of the travel speeds included in the predetermined time zone collected for the second vehicle group, by the processor.

10. The evaluation method according to claim 9, wherein the predetermined time zone is a day of a week.

11. A non-transitory computer-readable recording medium storing an evaluation program that causes a computer to execute a process comprising:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group; and
evaluating the specific area based on a result of comparison between a tendency of values indicated by the pieces of the data of the travel speeds collected for the first vehicle group and a tendency of values indicated by the pieces of the data of the travel speeds collected for the second vehicle group.

12. A non-transitory computer-readable recording medium storing an evaluation program that causes a computer to execute a process comprising:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group; and
controlling whether to give an alert in accordance with approaching or entrance to the specific area depending on a result of comparison between a tendency of values indicated by the pieces of the data of the travel speeds collected for the first vehicle group and a tendency of values indicated by the pieces of the data of the travel speeds collected for the second vehicle group.

13. An information processing apparatus comprising:
a processor that executes a process including:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group; and
evaluating the specific area based on a result of comparison between a tendency of values indicated by the pieces of the data of the travel speeds collected for the first vehicle group and a tendency of values indicated by the pieces of the data of the travel speeds collected for the second vehicle group.

14. An information processing apparatus comprising:
a processor that executes a process including:
collecting pieces of data of travel speeds corresponding to positions included in a specific area for each of a first vehicle group and a second vehicle group, based on a piece of data of a travel speed corresponding to a position of each of vehicles included in the first vehicle group and a piece of data of a travel speed corresponding to a position of each of vehicles included in the second vehicle group; and
controlling whether to give an alert in accordance with approaching or entrance to the specific area depending on a result of comparison between a tendency of values indicated by the pieces of the data of the travel speeds collected for the first vehicle group and a tendency of values indicated by the pieces of the data of the travel speeds collected for the second vehicle group.
